(19) United States
(12) Patent Application Publication
(10) Pub. No.: US 2025/0229906 A1
(43) Pub. Date: Jul. 17, 2025

(54) Laminate Structure with Integrated Power Distribution

(71) Applicant: The Boeing Company, Arlington, VA (US)

(72) Inventors: Michael Jason BAILEY, Summerville, SC (US); Matthew T. GREEN, Charleston, SC (US); Daniel B. FREEMAN, Goose Creek, SC (US); Richard LI, Cambridge, MA (US)

(73) Assignee: The Boeing Company, Arlington, VA (US)

(21) Appl. No.: 18/474,200

(22) Filed: Sep. 25, 2023

(51) Int. Cl. B64D 15/12; B64D 29/08; B64D 33/02

(52) U.S. Cl. CPC B64D 15/12; B64D 33/02; B64D 2033/0233

(57) ABSTRACT

A laminated structure includes a structural segment, an electrical segment, and a conductive insert. The structural segment includes multiple structural support layers in a stack. The electrical segment is next to the structural segment along a thickness of the laminate structure. The electrical segment includes an embedded conductive element sandwiched between a first dielectric ply and a second dielectric ply. The electrical segment includes a bus strip that is electrically connected to an electrical load. The embedded conductive element is electrically connected to the bus strip across the second dielectric ply. The conductive insert is loaded into a thru-hole defined through the stack of the structural support layers. The conductive insert is electrically connected to the embedded conductive element across the first dielectric ply and provides in-plane routing for an electrical circuit defined within the thickness of the laminate structure.

### GOVERNMENT LICENSE RIGHTS

This invention was made with US Government support under contract 693KA9-21-T-00001 awarded by the Federal Aviation Administration. The US Government has certain rights in the invention.

### FIELD OF THE DISCLOSURE

Embodiments of the present disclosure generally relate to a multifunctional laminated composite structure that has integrated electrical current routing without wires to distribute power and/or signals. In some embodiments, the laminate composite structure can be used to construct a portion of an aircraft, such as an inlet cowl of a nacelle.

### BACKGROUND

Composite materials have been used as structural elements in various applications. Composite materials, such as fiber-reinforced polymers, have a relatively high strength to weight ratio. The high strength to weight ratio makes these materials desirable for vehicle construction, such as aircraft. These materials typically include many layers or plies of a reinforcement material bound within a matrix material to form a heterogenous material with combined properties that are different from the reinforcement material and matrix materials individually.

For some applications, it is desirable for the composite material to provide multiple functions. For example, it may be desirable to have a single laminate structure that provides both structural support and conducts current for powering an electrical load, communication transmission, and/or the like. Power distribution to embedded conductive materials within a laminated composite structure requires a means of delivering electric current to a known location in the thickness and specific region of the laminated structure.

Some existing systems embed one or more insulated wires through the thickness of the laminate structure. The assembly of the laminate may include forming cut-outs or splices through multiple plies, and feeding the wire through the cut-outs as the plies are sequentially applied on a mandrel or other tool to form a laminate stack up. This process of embedding wires into the structure at multiple locations during the structure formation can be detrimental to structural properties of the laminate structure and can inhibit proper interfaces between structural plies of the laminate structure and adjacent components, such as a cellular core. For example, routing wires through the surface of the laminate structure at multiple locations may result in discontinuities, such as bumps and stress concentrations, within the laminate structure. The discontinuities may degrade the structural properties of the laminate, requiring additional plies (and therefore weight) to satisfy material strength requirements. Furthermore, the insulation material of the wires may contaminate the matrix material (e.g., resin) of the laminate structure, degrading the material properties. Wire stripping and other wire preparation and routing tasks may increase the risk of foreign object debris (FOD) contaminating the laminate structure. The embedded wires also may introduce a failure risk attributable to handling of the wires and interference between the wires and adjacent components. During the life of the system, the embedded wires may experience fatigue and wear over time which could cause the wires to fail. Furthermore, in at least one application, perforations are formed through the laminate structure. The perforations can be used for noise attenuation, distributing a fluid through the laminate structure, and/or the like. With embedded electrical wires present within the thickness of the laminate structure, there is a risk that wires may be damaged during the perforation formation process, which could render the electrical load that is powered by the wires inoperable. Conversely, avoiding the embedded wires may undesirably restrict the area that is perforated, limiting the effectiveness of the perforations.

### SUMMARY OF THE DISCLOSURE

A need exists for a laminate structure that is multi-functional and can distribute electrical power within a thickness of the laminate structure for powering an electrical load without containing insulated wires.

Certain embodiments of the present disclosure provide a laminate structure that includes a structural segment, an electrical segment, and a conductive insert. The structural segment includes multiple structural support layers in a stack. The electrical segment is next to the structural segment along a thickness of the laminate structure. The electrical segment includes an embedded conductive element sandwiched between at least a first dielectric ply and a second dielectric ply. The electrical segment includes a bus strip that is electrically connected to an electrical load. The embedded conductive element is electrically connected to the bus strip across the second dielectric ply. The conductive insert is loaded into a thru-hole defined through the stack of the structural support layers. The conductive insert is electrically connected to the embedded conductive element across the first dielectric ply and provides in-plane routing for an electrical circuit defined within the thickness of the laminate structure.

Certain embodiments of the present disclosure provide a method of forming a laminate structure. The method includes forming a structural segment to include multiple structural support layers in a stack. The method includes forming an electrical segment disposed next to the structural segment along a thickness of the laminate structure. The electrical segment includes an embedded conductive element sandwiched between a first dielectric ply and a second dielectric ply. The electrical segment includes a bus strip that is electrically connected to an electrical load. The embedded conductive element is electrically connected to the bus strip across the second dielectric ply. The method includes loading a conductive insert into a thru-hole defined through the stack of the structural support layers. The conductive insert is electrically connected to the embedded conductive element across the first dielectric ply. The embedded conductive element provides in-plane routing for an electrical circuit defined within the thickness of the laminate structure.

Certain embodiments of the present disclosure provide a laminate structure that includes an inner face sheet, a cellular core layer, a structural segment, an electrical segment, and a surface segment. The cellular core layer is disposed between the inner face sheet and the structural support layers along a thickness of the laminate structure. The structural segment includes multiple structural support layers in a stack. The surface segment defines an exterior surface of an aircraft. The electrical segment is disposed between the surface segment and the structural segment along the thickness of the laminate structure. The electrical segment includes an embedded conductive element sandwiched between a first dielectric ply and a second dielectric ply. The electrical segment includes a bus strip that is electrically connected to an electrical load. The embedded conductive element is electrically connected to the bus strip across the second dielectric ply. The laminate structure also includes a conductive insert loaded into a thru-hole defined through the stack of the structural support layers. The conductive insert is electrically connected to the embedded conductive element across the first dielectric ply and provides in-plane routing for an electrical circuit defined within the thickness of the laminate structure.

### BRIEF DESCRIPTION OF THE DRAWINGS

These and other features, aspects, and advantages of the present disclosure will become better understood when the following detailed description is read with reference to the accompanying drawings in which like numerals represent like parts throughout the drawings, wherein:

FIG. 1 illustrates a laminate structure according to an embodiment of the present disclosure.

FIG. 2 illustrates a cross-sectional view of the laminate structure according to an embodiment.

FIG. 3 illustrates a cross-sectional view of the laminate structure according to an embodiment.

FIG. 4 is a perspective illustration of an aircraft.

FIG. 5 illustrates an embodiment of a nacelle of a propulsion system of the aircraft according to an embodiment.

FIG. 6 is a front view of an inlet cowl of the nacelle shown in FIG. 5.

FIG. 7 shows a portion of the inlet cowl indicated by a dashed circle in FIG. 6.

FIG. 8 illustrates a cross-sectional view of the laminate structure along line 3-3 according to an embodiment in which the laminate structure is used to form a portion of an inlet cowl of an aircraft.

FIG. 9 is a flow chart of a method of forming a laminate structure according to an embodiment.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Certain embodiments of the present disclosure provide a multi-functional laminated composite structure with embedded conductive elements for integrated power distribution. The laminated composite structure (also referred to herein as simply laminated structure) includes multiple layers of different material elements (e.g., sheets, plies, films, etc.) stacked on top of each other and bonded together to form a one-piece structure. The embedded conductive elements are located within a thickness of the laminated structure between respective inner and outer surfaces of the laminated structure. The conductive elements may route electric current to an electrical load. In an embodiment, the electrical load is also a component of the laminated structure. For example, the electrical load may be a heating element in the form of an electrically resistive ply (e.g., sheet). The heating element may be disposed within a thickness of the laminated structure and may function to heat the laminated structure, such as to prevent ice accretion along the outer surface of the laminated structure. In an embodiment, the conductive elements of the laminated structure include conductive inserts which are loaded into corresponding holes along the laminated structure. The holes may extend through structural support layers of the laminated structure. In an example, at least some of the structural support layers may be electrically conductive. In that case, the laminated structure includes dielectric elements to electrically isolate the conductive inserts from the electrically conductive material of the structural support layers to avoid electrical shorting and/or undesirable electrical loss.

At least one technical effect provided by the laminated structure according to the embodiments described herein is improved electrical path routing through the laminated structure from a power ingress location to a power egress location. In one or more embodiments, the laminated structure does not include any insulated wires embedded within the thickness of the laminated structure, which avoids the various drawbacks described above with reference to incorporating wires into laminated composite structures. Furthermore, in various embodiments the laminated structure includes one or more electrically conductive routing elements which provide electrically conductive pathways, within the thickness of the laminated structure, from the conductive inserts to the electrical load. For example, the laminated structure may include a first bus strip (e.g., positive contact) that supplies current to an electrical load and a second bus strip (e.g., negative contact) that receives the current from the electrical load. The conductive routing elements may include one or more first routing elements that provide an ingress path from a first conductive insert (e.g., positive terminal) to the first bus strip. Additionally, or alternatively, the conductive routing elements may include one or more second routing elements that provide an egress path from the second bus strip to a second conductive insert (e.g., negative terminal). The conductive routing element(s) may be flat, electrically conductive strips, sheets, films, discs, or the like that are stacked in one or more of the layers of the laminated structure. The presence of the conductive routing element(s) beneficially provides customizability and allows for efficient packaging. For example, known systems that do not use embedded wires require direct connection between external wires (or other conductive elements) and the powered components (e.g., the electrical load, the positive and negative bus strips, etc.). This may result in a cluster of wires connected to the composite structure at various spaced apart locations. The laminated structure described herein may utilize the conductive routing element(s) to enable positioning the conductive inserts proximate to each other to reduce and simplify the wiring by centralizing the electrical connections to a particular region. For example, by centralizing the electrical connections, external wires that connect to the conductive inserts can be bound in an organized wire harness. Furthermore, the conductive routing element(s) enable positioning the conductive inserts at locations that are spaced apart from other components to avoid interfering with the other components or interfaces between adjacent components. For example, the conductive inserts may be laterally spaced apart from a cellular core that is bonded to the structural support layers. The external wires can be welded or otherwise electrically connected to the conductive inserts without interfering with, or extending through, the cellular core.

The laminated structure described herein can be used in various applications. One example application is in the construction of aircraft. For example, the laminated structure described herein can be formed to define a portion of a skin of an aircraft. The laminated structure can be used to form an inlet cowl of a nacelle of an aircraft. In such an application, the laminated structure may include a cellular core stacked adjacent to, or proximate to, the structural support layers. The laminated structure may also include perforations which provide noise attenuation, anti-icing by permitting a liquid to seep through the laminated structure, and/or the like. Although description herein refers to the laminated structure being used for the inlet cowl of the nacelle, the laminated structure could be used to form the skin along the wings, fuselage, empennage, and/or the like in other embodiments. The laminated structure with integrated power distribution described herein can be utilized in a variety of different vehicular applications, as well as non-vehicular applications.

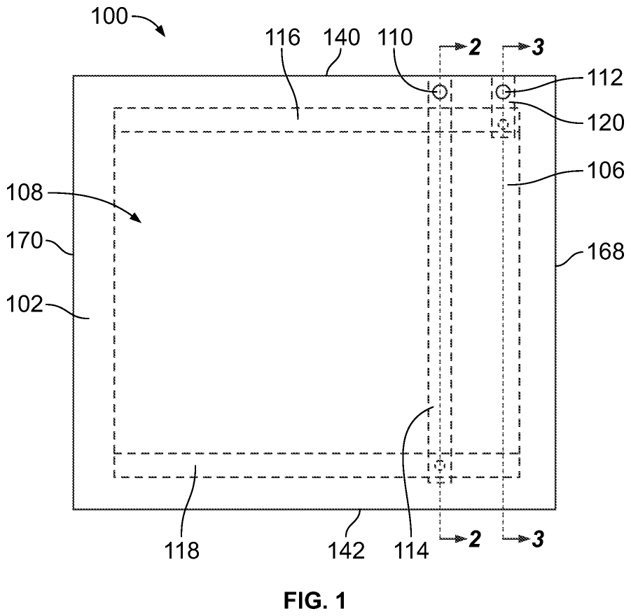

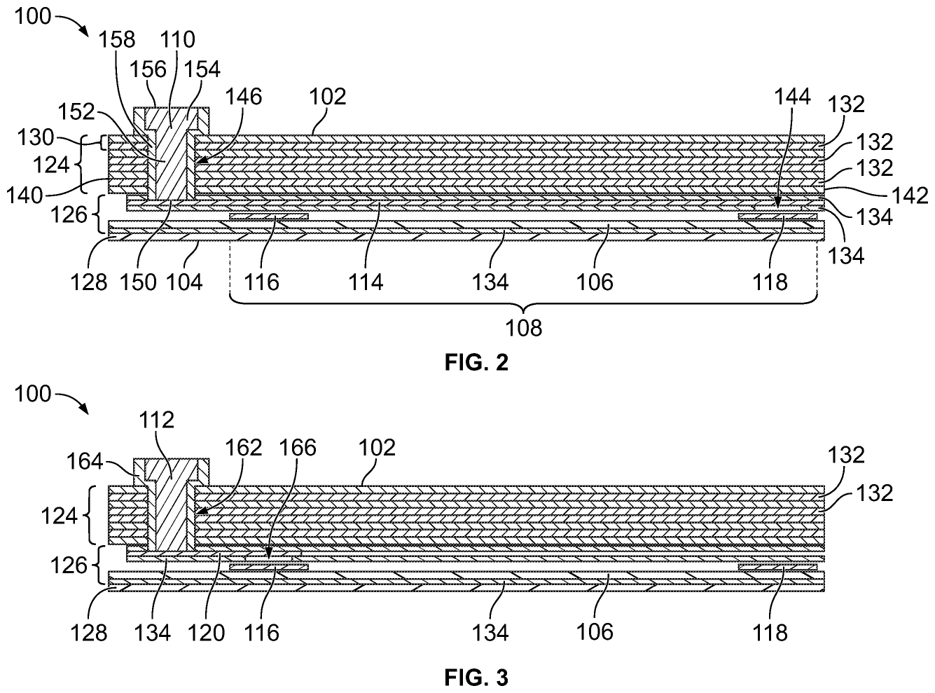

Referring now to the drawings, FIG. 1 illustrates a laminated composite structure 100 (also referred to as laminated structure) according to an embodiment of the present disclosure. The laminated structure 100 has a rectangular shape in FIG. 1, but may have other shapes in other embodiments. Furthermore, prior to use, the laminated structure 100 may be bent, molded, or otherwise formed into a non-planar shape to have a designated contour. In an example application, the laminated structure 100 may form a panel of an inlet cowl of an aircraft nacelle. The laminated structure 100 has a top side 102 and a bottom side 104 (shown in FIG. 2) that is opposite the top side 102. Various components of the laminated structure 100 are disposed beneath the top side 102 and are obstructed from view in FIG. 1. Some of the obstructed components are indicated in phantom in FIG. 1. Optionally, the top side 102 may be defined by a structural support layer, an acoustic cellular core, an inner face sheet, or the like. The laminated structure 100 may include an electrical load 106 that is integrated into the laminated structure 100. The electrical load 106 defines a powered zone 108. The powered zone 108 is located along a central area of the laminated structure 100 in FIG. 1. The powered zone 108 may occupy a majority of the area of the laminated structure 100. Optionally, the powered zone 108 may have a different relative location and/or a different size than shown in FIG. 1. In an embodiment, the powered zone 108 represents a heated area. The powered zone 108 may be heated to prohibit ice accretion, to maintain the temperature of the laminated structure 100 within a designated range, and/or the like. The electrical load 106 may include an electrically resistive ply that converts electrical energy to thermal energy.

The laminated structure 100 includes one or more conductive inserts for establishing an electrical connection to an external power source. In an embodiment, the laminated structure includes a first conductive insert 110 and a second conductive insert 112. The first conductive insert 110 may be electrically connected to a first wire or other external conductor. The second conductive insert 112 may be electrically connected to a second wire or other external conductor. The first and second wires may be independently electrically connected to different terminals of a power source, such as a battery pack, to define an electrical circuit path. The electrical circuit path extends from the power source to the laminated structure 100 and back again to the power source. More specifically, electric current may be conveyed from the power source along the second wire to the second conductive insert 112. The electric current may be conveyed from the second conductive insert 112 through the laminated structure 100 via one or more second embedded conductive elements 120 to a first bus strip 116 which supplies the current to the electrical load 106. Return current from the electrical load 106 is supplied by a second bus strip 118 along one or more first embedded conductive elements 114 within the laminated structure 100 to the first conductive insert 110. From the first conductive insert 110, the electric current may be conveyed along the first wire to the power source to complete the circuit path. Along the powered zone 108, the electric current may be conveyed via the electrical load 106 in a general direction from the first bus strip 116 to the second bus strip 118. The electrical load 106 may have an electrical resistance that generates heat along the powered zone 108. The direction of current conduction along the circuit path may be different than described. For example, the first conductive insert 110 may be disposed along the inbound or ingress path of the circuit, and the second conductive insert 112 may be disposed along the return or egress path.

FIG. 2 illustrates a cross-sectional view of the laminated structure 100 according to an embodiment. The cross-section in FIG. 2 is taken along line 2-2 in FIG. 1. The cross-section extends through the first conductive insert 110. As described above, the laminated structure 100 includes a stack of multiple layers bonded together. For ease of description, some of the layers are spaced apart from one another in FIG. 2, although the layers are compressed together in the finished product. The layers include different components with different material properties. In an embodiment, the laminated structure 100 includes a structural segment 124, an electrical segment 126, and a surface segment 128. The structural segment 124 may be defined by multiple structural support layers 130 in a stack that provide structural rigidity. In an example, the structural support layers 130 may be composed of structural plies 132. Optionally, the structural plies 132 may include electrically conductive material to provide strength and rigidity. The structural plies 132 may be sufficiently electrically conductive to be able to provide a conductive pathway that presents a risk for electrical shorting. The potential shorting path may be an unintended consequence of forming the structural plies 132 with a composition that provides desired strength per weight characteristics and relatively low cost. For example, the structural plies 132 may include an electrically conductive material such as carbon and/or one or more metals. The carbon material may include carbon (e.g., graphite) fibers. The structural plies 132 in the structural support layers 130 may be impregnated with a curable resin, such as an epoxy resin or the like. In an example in which the structural plies 132 include an electrically conductive material, the structural support layers 130 may include a carbon-fiber reinforced polymer (CFRP) material. In an alternative embodiment, the structural support layers 130 may not be electrically conductive. For example, the structural support layers 130 may have only dielectric and/or electrically non-conductive plies. In that case, the structural support layers 130 may be fiberglass or the like.

The electrical segment 126 includes a stack of dielectric plies 134, the first bus strip 116, the second bus strip 118, the first conductive element 114, and the electrical load 106. The dielectric plies 134 are disposed between the other elements 114, 116, 118, 106 to provide electrical insulation and control the electrical pathways between the elements. For example, the dielectric plies 134 may be arranged in specific locations to electrically insulate (e.g., isolate) the electrical system from conductive elements and prevent short circuiting. In FIG. 2, the electrical segment 126 includes a first set of one or more dielectric plies 134 that is next to the structural support layers 130. The first set includes at least a first dielectric ply 134. The first dielectric ply 134 may be the only ply in the set or may be one or multiple dielectric plies 134 in the set that are stacked and bonded together. The first dielectric ply 134 optionally may be bonded to the adjacent structural support layer 130 via an adhesive. The first embedded conductive element 114 is below the first dielectric ply 134. The first dielectric ply 134 may electrically insulate the conductive element 114 from the structural support layers 130. A second dielectric ply 134 is disposed below the first embedded conductive element 114. For example, the first embedded conductive element 114 may be sandwiched between the first and second dielectric plies 134. The first and second bus strips 116, 118 are located in the layer below the second dielectric ply 134. The electrical load 106 is disposed immediately below the bus strips 116, 118. The electrical load 106 may be in direct contact with the bus strips 116, 118 to provide electrical connections with the bus strips 116, 118. The space that extends from the first bus strip 116 to the second bus strip 118 represents the powered zone 108 shown in FIG. 1.

In an embodiment, the electrical load 106 may be a heater element 106. The heater element 106 may include an electrically resistive ply that converts electrical energy to thermal energy. The heat that is generated may be used to regulate the temperature along the surface segment 128, to prevent ice accretion along the surface segment 128, and/or the like. As shown in FIG. 2, a dielectric ply 134 may be disposed between the surface segment 128 and the heater element 106 to prevent shorting to the exterior surface. An adhesive may be used to bond the heater element 106 and/or the surface segment 128 to the dielectric ply 134 therebetween. In an alternative embodiment, the surface segment 128 may include a dielectric material and may be bonded directly to the heater element 106 without an intervening dielectric ply 134. The heater element 106 may include a continuous conductive material that is capable of conducting an electric current. In an example, the heater element 106 includes a carbon non-woven material as an electrically resistive heater material. In other embodiments, the conductive material may include other non-woven materials, woven materials, metallic foil, a formed sheet, or the like.

The conductive element 114 may provide in-plane electrical routing from the first conductive insert 110 to the second bus strip 118 to define a portion of an electrical circuit through the laminated structure 100. For example, as shown in FIG. 1, the conductive element 114 may extend a relatively long length from the first conductive insert 110 to the second bus strip 118. The length of the conductive element 114 optionally may represent a majority of the length of the laminated structure 100 from a first edge 140 to an opposite second edge 142. The conductive element 114 may be an electrically conductive strip that has a width as indicated by the broken lines in FIG. 1. The conductive element 114 may be formed of a thin metallic foil, sheet, film, and/or the like. Optionally, the conductive element 114 may include metallic particles encased in a binder. In another example, the conductive element 114 may include carbon or another non-metallic conductive material. The conductive element 114 is electrically connected to the second bus strip 118 across a thickness of the second dielectric ply 134. For example, the second dielectric ply 134 may include an opening or cut-out 144 along the area that forms an interface or joint between the second bus strip 118 and the conductive element 114. For example, the opening 144 is located directly between the two conductive components such that the second bus strip 118 covers the opening 144 from below and the conductive element 114 covers the opening 144 from above. In an embodiment, during the manufacturing process to produce the laminated structure 100, the stack is compressed and cured such that the second bus strip 118 and/or the conductive element 114 extend through the opening 144 to make physical contact and establish an electrically conductive connection. In an alternative embodiment, an electrically conductive material, such as a solder, may be applied within the opening 144 during assembly to assist with establishing the electrical connection between the bus strip 118 and the conductive element 114 through the thickness of the dielectric ply 134. As shown in FIG. 2, the conductive element 114 is electrically insulated from the first bus strip 116 by the second dielectric ply 134. For example, the second dielectric ply 134 has no opening along the area that forms the interface between the first bus strip 116 and the conductive element 114. The first bus strip 116 is electrically connected to the second conductive element 120, as shown in FIG. 3.

In an embodiment, the first conductive insert 110 extends through the thickness of the structural segment 124 and is electrically connected to the first conductive element 114. For example, the structural support layers 130 may define a thru-hole 146 that is open along the top side 102 of the structural segment 124. The thru-hole 146 may extend through the full thickness of the structural segment 124 to provide an opening to access the electrical segment 126. In an example, the first dielectric ply 134 of the electrical segment 126 at the interface with the structural segment 124 may have a cut out or opening that aligns with the thru-hole 146. During the assembly process, the first conductive insert 110 may be loaded from the top side 102 into the thru-hole 146 until a distal end 150 of the conductive insert 110 establishes an electrically conductive connection with the first embedded conductive element 114. The distal end 150 optionally may physically contact the conductive element 114, either directly or via a conductive intermediary material. The conductive insert 110 may be a tab, plug, or the like. The conductive insert 110 may have a shaft 152 which extends to the distal end 150. In an example, the shaft 152 is cylindrical. The conductive insert 110 optionally may include a head 154 that is coupled to the shaft 152. When loaded, the head 154 projects beyond the structural support layers 130 along the top side 102. The head 154 may be wider in a lateral or radial direction than the shaft 152. The head 154 may have a flat end surface 156 on which an external wire may be welded to establish an electrical connection. Alternatively, the external wire may be clamped or crimped to the head to establish the electrical connection. The conductive insert 110 reduces the complexity of establishing an electrical connection to embedded elements within a laminated structure. For example, the conductive insert 110 avoids issues associated with feeding an external wire or other external element through a thickness of the laminated structure 100 to reach the first embedded conductive element 114 and secure the wire to the conductive element 114. For example, it would be difficult to weld an external wire to an embedded conductive element that is recessed within a thickness of a laminated structure, and the process risks introducing contaminants (e.g., FOD) into the laminated structure and/or damaging the laminated structure. The conductive insert 110 avoids these risks and provides an easily accessible end surface 156 on which to secure the end of an external wire.

In an embodiment, the first conductive insert 110 is disposed within a dielectric bushing 158. The dielectric bushing 158 is a hollow sleeve or sheath that surrounds at least the shaft 152 of the conductive insert 110 along the circumferential perimeter of the shaft 152. For example, the dielectric bushing 158 may not cover the distal end 150 of the shaft 152 to enable the distal end 150 to contact the embedded conductive element 114. Optionally, the dielectric bushing 158 may also surround the head 154. In such case, the dielectric bushing 158 may not cover at least a portion of the end surface 156 to enable the end surface 156 to electrically connect to the external wire. The dielectric bushing 158 may be composed of a dielectric material to electrically insulate the conductive insert 110 from the structural support layers 130, which may include electrically conductive material. The dielectric bushing 158 may be loaded with the conductive insert 110 into the thru-hole 146. The dielectric bushing 158 extends between and separates the conductive insert 110 from the structural plies 132. The dielectric material of the bushing 158 may be a plastic, a glass, or the like. In an alternative embodiment in which the structural support layers 130 are dielectric (e.g., do not include electrically conductive plies), the laminated structure 100 optionally may not include the dielectric bushing 158.

The surface segment 128 is disposed along the bottom side 104. The surface segment 128 may define an exterior surface of a vehicle, such as an aircraft. The surface segment 128 may include paint, an exterior film (e.g., paint protection, etc.), an erosion shield, and/or the like. The erosion shield may be a metallic coating that protects the laminated structure 100 from leading edge damage, particularly when installed on the inlet of an aircraft nacelle.

FIG. 3 illustrates a cross-sectional view of the laminated structure 100 according to an embodiment. The cross-section in FIG. 3 is taken along line 3-3 in FIG. 1. The cross-section extends through the second conductive insert 112. The cross-sectional view along line 3-3 is similar to the view in FIG. 2 along line 2-2 except for a few notable differences. The second conductive insert 112 may have the same or a similar size, shape, and/or composition as the first conductive insert 110. The second conductive insert 112 may be loaded through a second thru-hole 162 that is defined through the structural segment 124 and extends from the top side 102. The second conductive insert 112 may be disposed within a dielectric bushing 164 that is similar to the dielectric bushing 158 that surrounds the first conductive insert 110. For example, the dielectric bushing 164 may electrically insulate or separate the conductive insert 112 from the structural plies 132 of the structural segment 124.

The second conductive insert 112 is electrically connected to the second embedded conductive element 120 within the electrical segment 126. The second embedded conductive element 120 provides in-plane electrical routing from the second conductive insert 112 to the first bus strip 116. For example, as shown in FIG. 1, the conductive element 120 may extend a relatively short length from the second conductive insert 112 to the first bus strip 116. The conductive element 120 may be an electrically conductive strip that has a width as indicated by the broken lines in FIG. 1. The conductive element 120 may be formed of a thin metallic foil, sheet, film, and/or the like. Optionally, the conductive element 120 may include metallic particles encased in a binder. In another example, the conductive element 120 may include carbon or another non-metallic conductive material. The second embedded conductive element 120 may be sandwiched between the first and second dielectric plies 134. For example, the second embedded conductive element 120 may be in a common layer or plane as the first embedded conductive element 114, but spaced apart from one another as shown in FIG. 1. The second embedded conductive element 120 is electrically connected to the first bus strip 116 across a thickness of the second dielectric ply 134. For example, the second dielectric ply 134 may include an opening or cut-out 166 along the area that forms an interface or joint between the first bus strip 116 and the conductive element 120. For example, the opening 166 is located directly between the two conductive components such that the first bus strip 116 covers the opening 166 from below and the conductive element 120 covers the opening 166 from above. In an embodiment, during the manufacturing process to produce the laminated structure 100, the stack is compressed and cured such that the first bus strip 116 and/or the conductive element 120 extend through the opening 166 to make physical contact with each other and establish an electrically conductive connection. In an alternative embodiment, an electrically conductive material, such as a solder, may be applied within the opening 166 during assembly to assist with establishing the electrical connection between the bus strip 116 and the conductive element 120 through the thickness of the dielectric ply 134. As shown in FIG. 3, the conductive element 120 does not extend the full distance to the second bus strip 118 and is also spaced apart along the thickness of the laminated structure 100 by the second dielectric ply 134. As such, the conductive element 120 is not electrically connected to the second bus strip 118.

Referring now back to FIG. 1, the first and second conductive inserts 110, 112 provide accessible electrical connection points to the laminated structure 100. The embedded conductive elements 114, 120 provide enhanced electrical routing within the laminated structure 100. The electrical routing enables placing the conductive inserts 110, 112 in desired locations, which may be spaced apart from the bus strips 116, 118 and/or the electrical load 106. For example, the conductive inserts 110, 112 may be located proximate to each other, without being electrically connected to each other. In FIG. 1, both conductive inserts 110, 112 are located proximate to the first edge 140 in an area between the powered zone 108 and the first edge 140. Positioning the conductive inserts 110, 112 next to each other provides ease of electrical connection, as the positive and negative external wires can be routed together from the power source to the laminated structure 100 and then separated at the ends for securing to the corresponding conductive inserts 110, 112. In an embodiment, the laminated structure 100 in FIG. 1 is a panel that is assembled next to one or more additional panels of the laminated structure 100. For example, a second panel of the laminated structure 100 may be installed along a third edge 168 of the laminated structure 100 shown in FIG. 1. Optionally, a third panel of the laminated structure may be installed along a fourth edge 170 of the laminated structure 100 shown in FIG. 1. The conductive inserts 110, 112 may represent positive and negative terminals for establishing an electrical circuit with an external power source for powering the electrical load 106. The conductive inserts 110, 112 may be the only exposed electrically conductive components along the top side 102. The other electrically conductive components (e.g., the bus strips 116, 118, the electrical load 106, the embedded conductive elements 114, 120) may be embedded within the thickness of the laminated structure 100 and spaced apart from the top and bottom sides 102, 104.

In one or more applications, the laminated structure 100 may be installed on a vehicle. For example, the laminated structure 100 may be installed along an exterior surface (or skin) of the vehicle. The structural segment 124 may provide structural rigidity for the vehicle. The surface segment 128 may define a portion of the exterior surface of the vehicle. The laminated structure 100 is a multifunctional component that provides structural support and electrical power distribution for powering an electrical load. Optionally, the laminated structure 100 may provide one or more additional functions, such as noise attenuation. In an example, the vehicle is an aircraft.

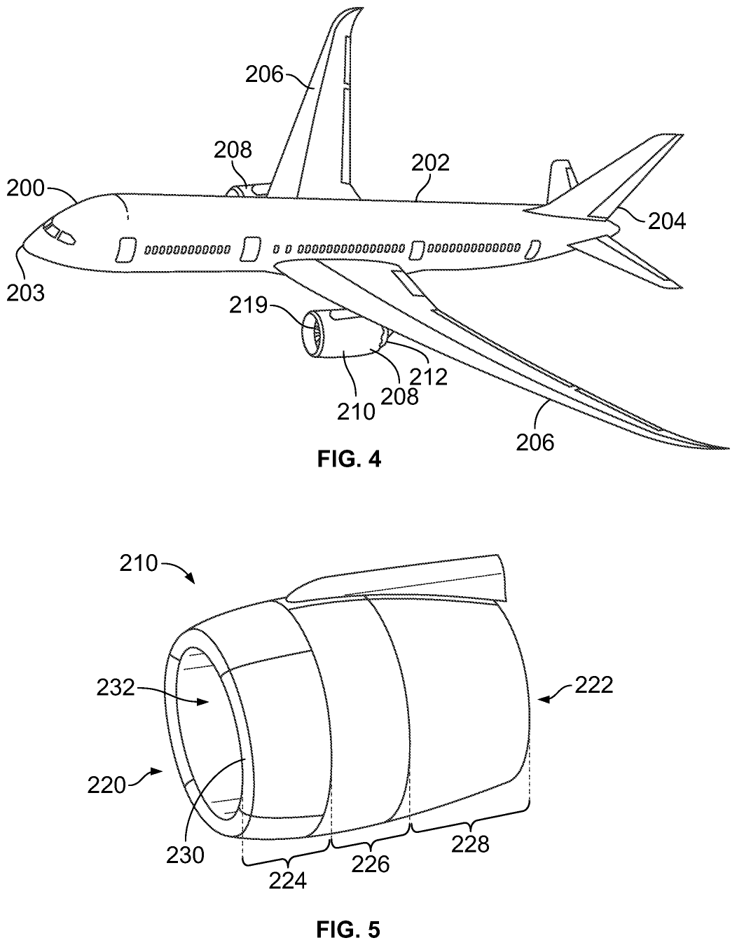

FIG. 4 is a perspective illustration of an aircraft 200. The laminated structure 100 shown in FIGS. 1-3 may be installed on the aircraft 200. The aircraft 200 may include a fuselage 202 extending from a nose 203 to an empennage 204. The empennage 204 may include one or more tail surfaces for directional control of the aircraft 200. The aircraft 200 includes a pair of wings 206 extending from the fuselage 202. One or more propulsion systems 208 propel the aircraft 200. The propulsion systems 208 are supported by the wings 206 of the aircraft 200, but may be mounted to the fuselage or tail in other types of aircraft. Each propulsion system 208 includes a rotor assembly 219 with rotors that spin to direct air.

The rotor assembly 219 of each propulsion system 208 is surrounded by a nacelle 210. The nacelle 210 is an outer casing or housing that holds the rotor assembly 219. The nacelle 210 includes an inlet section, referred to as an inlet cowl, at a leading or front end of the nacelle 210. The nacelle 210 may also include a fan cowl, a thrust reverser section, and an aft fairing section located behind the inlet cowl along a longitudinal length of the nacelle 210. The inlet cowl has an inner barrel that defines an air inlet duct for directing air to the rotor assembly 219. The nacelle 210 may have an exhaust nozzle 212 (e.g., a primary exhaust nozzle and a fan nozzle) at an aft end of the propulsion system 208. In an example, each propulsion system 208 may include or represent a gas turbine engine. The rotor assembly 219 may be a portion of the engine. The engine burns a fuel, such as gasoline, kerosene, biofuel, or other fuel source, to generate thrust for propelling the aircraft 200.

FIG. 5 illustrates an embodiment of the nacelle 210 of one of the propulsion systems 208 of the aircraft 200 according to an embodiment. The nacelle 210 extends a length from a front end 220 to an aft end 222 (opposite the front end 220). The nacelle 210 may include an inlet cowl 224, a fan cowl 226 disposed aft of the inlet cowl 224, and at least one aft section 228 disposed aft of the fan cowl 226. The inlet cowl 224 defines a leading edge 230 of the nacelle 210 at the front end 220 to direct air into a core 232 of the nacelle 210.

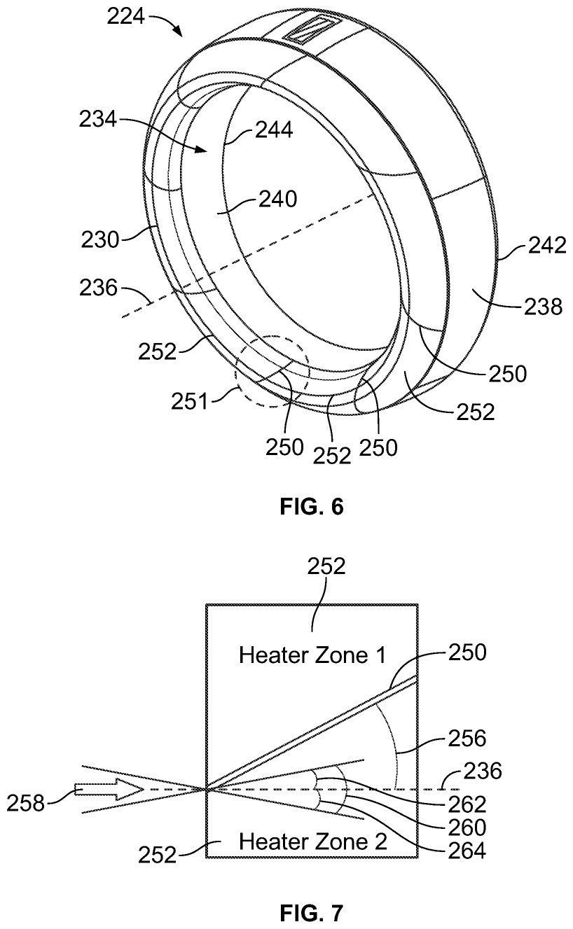

FIG. 6 is a front view of the inlet cowl 224 shown in FIG. 5. The inlet cowl 224 has an annular barrel shape that defines a central opening 234 that is fluidly connected to the core 232 (shown in FIG. 5) of the nacelle 210. The term “annular barrel shape” means that the inlet cowl 224 defines a closed, ring-like shape when viewed from the front. The annular barrel shape is oriented about a central longitudinal axis 236 that extends through the central opening 234. The inlet cowl 224 may have a generally cylindrical shape. For example, the leading edge 230 may be circular. The inlet cowl 224 directs air through the central opening 234 into the core 232.

The inlet cowl 224 has the leading edge 230, an outer side 238 and an inner side 240. The outer side 238 extends from the leading edge 230 to an outer aft edge 242. The inner side 240 extends from the leading edge 230 to an inner aft edge 244. The outer side 238 is radially outside of the inner side 240 and surrounds the inner side 240. The inner side 240 may define the central opening 234 that operates as an intake duct to supply air into the core 232 for the rotor assembly 219. The inlet cowl 224 may define a cavity (not shown) that is aft of the leading edge 230 and radially disposed between the outer side 238 and the inner side 240.

In an embodiment, the laminated structure 100 is used to define the leading edge 230 of the inlet cowl 224. For example, the laminated structure 100 may be assembled and then formed into the annular barrel shape. The surface segment 128 may define the skin of the inlet cowl 224 that is exposed to the ambient environment. Optionally, the laminated structure 100 shown in FIG. 1 is one panel of multiple different panels assembled side by side along the circumference of the inlet cowl 224. For example, a first laminated structure 100 may be assembled adjacent to a second laminated structure 100 that has the same or a similar composition, shape, and size as the first laminated structure 100. In another embodiment, the laminated structure 100 may be a unitary, one-piece structure that forms the entire annular leading edge 230 without any seams. In this one-piece embodiment, the laminated structure 100 optionally may include multiple electrical loads 106 within the thickness, and the electrical loads 106 may be separated from one another at seams.

The laminated structure(s) 100 may be a portion of an electric ice protection system (EIPS) that is used to meet engine ice accretion and ingestion requirements. The electrical loads 106 may be heater elements 106 (e.g., electrically resistive plies). The heater elements 106 are powered via the embedded electrical circuit components described with reference to FIGS. 1 through 3, such as the conductive inserts 110, 112, the embedded conductive elements 114, 120, and the bus strips 116, 118. The heater elements 106 convert electrical energy to thermal energy to warm the skin of the inlet cowl 224 along the leading edge 230. In an embodiment, the laminated structure(s) 100 include multiple heater elements 106 spaced apart from one another by seams 250. The heater elements 106 are arranged along the circumference of the inlet cowl 224, such that each heater element 106 defines a respective heater zone 252 that represents a circumferential section of the leading edge 230. Each heater zone 252 may represent the powered zone 108 shown in FIG. 1. The seams 250 are located between the heater zones 252. The heater zones 252 may be discrete and spaced apart from one another by the seams 250. The seams 250 extend from the leading edge 230 in an aft direction. Although the seams 250 are shown in FIG. 6, the seams 250 in practice may be covered by a one-piece surface segment 128 that defines the skin, such that the seams 250 would not be visible along the outside of the inlet cowl 224. The seams 250 are shown in FIG. 6 for ease of description.

With continued reference to FIG. 6, FIG. 7 shows a portion of the inlet cowl 224 indicated by the dashed circle 251 in FIG. 6. In an embodiment, the seams 250 are not oriented parallel to the central longitudinal axis 236 and/or the streamwise direction of airflow through the central opening 234. For example, the heater elements 106 may be arranged such that the seams 250 defined between adjacent heater elements 106 define an oblique angle 256 relative to the central longitudinal axis 236 and a streamwise direction of airflow 258 through the inlet cowl 224. The oblique angle 256 is not parallel or perpendicular. For example, the oblique angle 256 is between 1 and 89 degrees. In an embodiment, the oblique angle 256 may be between 20 and 70 degrees. Optionally, the oblique angle 256 may be between 30 and 60 degrees. In an embodiment, the seams 250 are oriented such that the seams 250 define an oblique angle relative to an entire range 260 of streamwise airflow directions that the aircraft 200 may experience in flight. For example, the range 260 may be defined between a maximum ascent angle 262 (while the aircraft is ascending) and a maximum descent angle 264 (while the aircraft is descending). The range 260 may be the maximum ascent angle 262 plus the maximum descent angle 264. As such, regardless of the angle of attack of the aircraft at a given time during typical flight conditions, the seams 250 are oriented oblique to the current streamwise direction of airflow 258.

In general, the seams 250 represent areas along the inlet cowl 224 that risk ice accumulation because the seams 250 may have a lower thermal flux than the adjacent heater zones 252. The ice accumulation can negatively affect aerodynamic properties of the aircraft 200 and may also potentially damage or increase wear on the rotor assembly 219. By orienting the heater elements 106 such that the seams 250 between the heater zones 252 are oblique to the streamwise direction of airflow 258, the inlet cowl 224 avoids ice build-up. For example, the cold air moving in the airflow direction 258 only intersects the seams 250 at small areas before traversing the heater zones 252. Most cold air is heated along a first heater area 252, then traverses across a seam 250 before being heated along a second heater area 252.

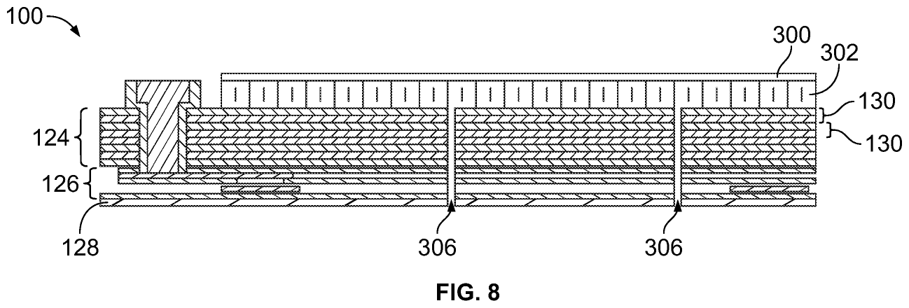

FIG. 8 illustrates a cross-sectional view of the laminated structure 100 along line 3-3 according to an embodiment in which the laminated structure 100 is used to form a portion of the inlet cowl 224 of an aircraft 200. The laminated structure 100 is the same as the laminated structure 100 in FIG. 3 with the addition of an inner face sheet 300 and a cellular core layer 302 disposed above the top side 102 of the structural segment 124. For example, the cellular core layer 302 is disposed between the inner face sheet 300 and the structural support layers 130 of the structural segment 124 within the thickness of the laminated structure 100. The cellular core layer 302 may be an open cell structure, such as an open cell honeycomb structure. FIG. 8 is shown for descriptive purposes and is not drawn to scale. For example, the cellular core layer 302 may have a significantly greater thickness than the relative thickness shown in FIG. 8. In an example, the second conductive insert 112 is spaced apart from the cellular core layer 302 and the face sheet 300. As such, the cellular core layer 302 and the face sheet 300 do not interface with securing an external wire to the second conductive insert 112. Although not shown, the first conductive insert 110 may also be spaced apart from the cellular core layer 302 and the face sheet 300.

In an embodiment, the laminated structure 100 includes perforations 306. The perforations 306 may be defined through various layers of the laminated structure 100. In an example, the perforations 306 continuously extend through the surface segment 128, the electrical segment 126, and the structural segment 124. The perforations 306 optionally may extend through at least a portion of the cellular core layer 302 and the inner face sheet 300. Two perforations 306 are shown in the illustrated FIG. 8, but the laminated structure 100 may have a plurality of perforations 306 in an array or pattern along the area of the laminated structure 100. The perforations 306 may be formed via laser drilling, mechanical drilling, or the like. The characteristics of the perforations 306, such as diameter, location, percent-open-area, etc., may be selected based on application-specific parameters. In an example, the perforations 306 may have micron scale diameters. The perforations 306 may provide acoustic attenuation which dampens the sounds emitted by the rotor assembly 219.

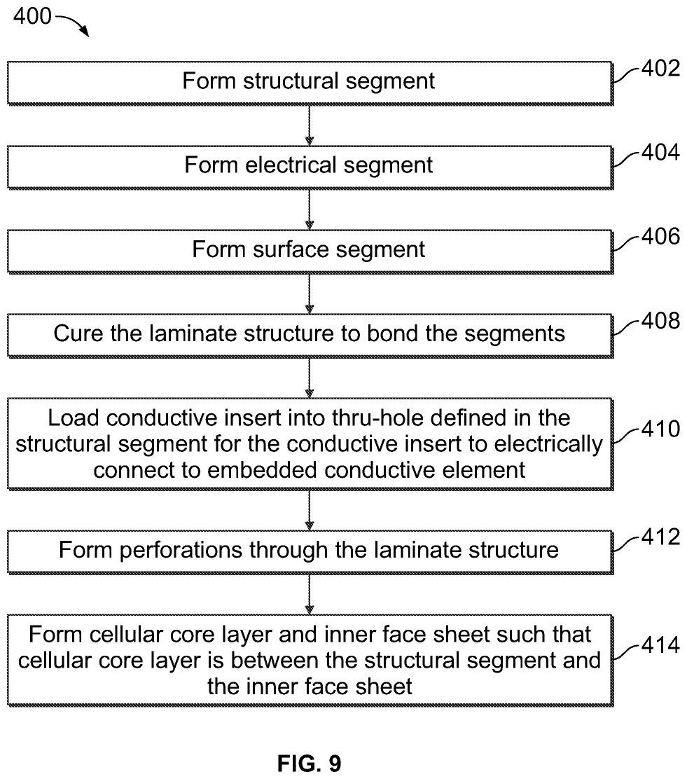

FIG. 9 is a flow chart 400 of a method of forming a laminated structure according to an embodiment. The laminated structure that is formed may be the laminated structure 100 described herein. The method in one or more embodiments may include additional steps, fewer steps, and/or different steps than the steps shown in the flow chart 400, and/or one or more of the steps may be performed in a different sequence than illustrated and described herein.

At step 402, a structural segment 124 is formed to include multiple structural support layers 130 in a stack. In an embodiment, the structural support layers 130 of the structural segment include electrically conductive material. For example, the structural support layers 130 may be CFRP.

At step 404, an electrical segment 126 is formed to be disposed next to the structural segment 124 along a thickness of the laminated structure 100. The electrical segment 126 may include an embedded conductive element 114 sandwiched between a first dielectric ply 134 and a second dielectric ply 134. The electrical segment 126 may include a bus strip 118 that is electrically connected to an electrical load 106. The embedded conductive element 114 may be electrically connected to the bus strip 118 across the second dielectric ply 134.

At step 406, a surface segment 128 is formed. The electrical segment 126 may be disposed between the structural segment 124 and the surface segment 128 within the thickness of the laminated structure 100. The surface segment 128 may include a metallic coating that provides an erosion shield. In an example, the surface segment 128 defines an exterior surface of a vehicle, such as an aircraft 200. The order at which the various segments 124, 126, 128 are formed can be modified. For example, the surface segment 128 may be formed first, followed by the electrical segment 126, and then the structural segment 124. Alternatively, the structural segment 124 may be formed first, followed by the electrical segment 126 and then the surface segment 128. In another example, the electrical segment 126 may be formed first.

At step 408, the laminated structure 100 is cured to bond the electrical segment 126 to the structural segment 124. The curing may also bond the electrical segment 126 to the surface segment 128. The segments 124, 126, 128 may be assembled on a tool, such as a mandrel. The curing may involve exposing the segments 124, 126, 128 on the tool to a heat treatment. The heat treatment may compress and bond the segments 124, 126, 128 together to form a unitary structure. After the curing process, the segments 124, 126, 128 may not be separated from each other without permanently damaging the laminated structure 100.

At step 410, a conductive insert 110 is loaded into a thru-hole 146 defined through the stack of the structural support layers 130. The conductive insert 110 may be electrically connected to the embedded conductive element 114 across the first dielectric ply 134. The embedded conductive element 114 may provide in-plane routing for an electrical circuit defined within the thickness of the laminated structure 100. In an embodiment in which the structural support layers 130 are electrically conductive, prior to loading the conductive insert 110 into the thru-hole 146, a dielectric bushing 158 may be applied to surround the conductive insert 110. The dielectric bushing 158 electrically insulates the conductive insert 110 from the electrically conductive material of the structural support layers 130.

Optionally, at step 412, a plurality of perforations 306 are formed that continuously extend through the surface segment 128, the electrical segment 126, and the structural segment 124. Optionally, at step 414, a cellular core layer 302 and an inner face sheet 300 are formed on the structural segment 124 such that the cellular core layer 302 is disposed between the inner face sheet 300 and the structural support layers 130 of the structural segment 124.

The method may include additional steps, such as forming (e.g., bending) the laminated structure 100 to achieve a contoured shape that is appropriate for an intended application. For example, the laminated structure 100 may be bent into a curved shape for installation along a leading edge 230 of an inlet cowl 224. The method may also include electrically connecting an external wire to the conductive insert 110. The external wire may be welded or otherwise secured to a flat end surface 156 of a head 154 of the conductive insert 110 that is above a top side 102 of the structural segment 124 and easy to access.

Further, the disclosure comprises examples according to the following clauses:

Clause 1. A laminated composite structure comprising:
a structural segment including multiple structural support layers in a stack;
an electrical segment disposed next to the structural segment along a thickness of the laminated composite structure, the electrical segment including at least a first embedded conductive element sandwiched between a first dielectric ply and a second dielectric ply, the electrical segment including at least a first bus strip that is electrically connected to an electrical load, the first embedded conductive element electrically connected to the first bus strip across the second dielectric ply; and
a first conductive insert loaded into a first thru-hole defined through the stack of the structural support layers, the first conductive insert electrically connected to the first embedded conductive element across the first dielectric ply to provide electrical circuit routing within the thickness of the laminated composite structure.

Clause 2. The laminated composite structure of Clause 1, wherein the electrical load is a heater element including an electrically resistive ply that converts electrical energy to thermal energy, wherein the first bus strip is disposed between the first embedded conductive element and the electrically resistive ply along the thickness of the laminated composite structure.

Clause 3. The laminated composite structure of Clause 1 or Clause 2, wherein the structural support layers of the structural segment include electrically conductive material, and the laminated composite structure comprises a dielectric bushing that is disposed within the first thru-hole and surrounds the first conductive insert to electrically insulate the first conductive insert from the electrically conductive material of the structural support layers.

Clause 4. The laminated composite structure of Clause 3, wherein the electrically conductive material comprises carbon fiber.

Clause 5. The laminated composite structure of any of Clauses 1-4, further comprising a second bus strip, a second conductive element, and a second conductive insert, wherein the second bus strip is spaced apart from the first bus strip, the second bus strip electrically connected to the electrical load, wherein the second conductive insert is loaded into a second thru-hole defined through the stack of the structural support layers, wherein the second embedded conductive element is electrically connected to a distal end of the second conductive insert and is electrically connected to the second bus strip such that the electrical circuit routing within the thickness of the laminated composite structure extends from the first conductive insert to the second conductive insert.

Clause 6. The laminated composite structure of Clause 5, wherein the second embedded conductive insert is in-plane with the first embedded conductive insert and spaced apart from the first embedded conductive insert.

Clause 7. The laminated composite structure of any of Clauses 1-6, further comprising a surface segment that defines an exterior surface of a vehicle, wherein the electrical segment is disposed between the structural segment and the surface segment within the thickness of the laminated composite structure.

Clause 8. The laminated composite structure of Clause 7, wherein the vehicle is an aircraft, and the laminated composite structure forms a portion of an inlet cowl of a nacelle.

Clause 9. The laminated composite structure of Clause 8, wherein the laminated composite structure defines a plurality of perforations that continuously extend through the surface segment, the electrical segment, and the structural segment.

Clause 10. The laminated composite structure of Clause 8, wherein the electrical load includes a first heater element and the first heater element is separated from a second heater element of a second laminated composite structure along a circumference of the inlet cowl by a seam, wherein the seam extends from a leading edge of the inlet cowl in an aft direction to define an oblique angle relative to a streamwise direction of airflow through the inlet cowl when in flight.

Clause 11. The laminated composite structure of any of Clauses 1-10, wherein the first conductive insert includes a shaft and a head, wherein at least a portion of the head is exposed beyond a top side of the structural segment and an external wire is electrically connected to the portion of the head that is exposed.

Clause 12. The laminated composite structure of any of Clauses 1-11, further comprising an inner face sheet and a cellular core layer, the cellular core layer disposed between the inner face sheet and the structural support layers within the thickness of the laminated composite structure.

Clause 13. A method of forming a laminated composite structure, the method comprising:
forming a structural segment to include multiple structural support layers in a stack;
forming an electrical segment disposed next to the structural segment along a thickness of the laminated composite structure, the electrical segment including an embedded conductive element sandwiched between a first dielectric ply and a second dielectric ply, the electrical segment including a bus strip that is electrically connected to an electrical load, the embedded conductive element electrically connected to the bus strip across the second dielectric ply; and
loading a conductive insert into a thru-hole defined through the stack of the structural support layers, the conductive insert electrically connected to the embedded conductive element across the first dielectric ply, wherein the embedded conductive element provides electrical circuit routing within the thickness of the laminated composite structure.

Clause 14. The method of Clause 13, further comprising curing the laminated composite structure to bond the structural segment to the electrical segment.

Clause 15. The method of Clause 13 or Clause 14, wherein the structural support layers of the structural segment include electrically conductive material, and loading the conductive insert into the thru-hole comprises applying a dielectric bushing to surround the conductive insert prior to loading the conductive insert into the thru-hole such that the dielectric bushing electrically insulates the conductive insert from the electrically conductive material of the structural support layers.

Clause 16. The method of any of Clauses 13-15, further comprising forming a surface segment that defines an exterior surface of a vehicle, wherein the electrical segment is disposed between the structural segment and the surface segment within the thickness of the laminated composite structure.

Clause 17. The method of Clause 16, further comprising forming a plurality of perforations that continuously extend through the surface segment, the electrical segment, and the structural segment.

Clause 18. A laminated composite structure comprising:
an inner face sheet;
a structural segment including multiple structural support layers in a stack;
a cellular core layer disposed between the inner face sheet and the structural support layers along a thickness of the laminated composite structure;
a surface segment that defines an exterior surface of an aircraft;
an electrical segment disposed between the surface segment and the structural segment along the thickness of the laminated composite structure, the electrical segment including an embedded conductive element sandwiched between a first dielectric ply and a second dielectric ply, the electrical segment including a bus strip that is electrically connected to an electrical load, the embedded conductive element electrically connected to the bus strip across the second dielectric ply; and
a conductive insert loaded into a thru-hole defined through the stack of the structural support layers, the conductive insert electrically connected to the embedded conductive element across the first dielectric ply for electrical circuit routing within the thickness of the laminated composite structure.

Clause 19. The laminated composite structure of Clause 18, wherein the laminated composite structure forms a portion of an inlet cowl of a nacelle of the aircraft, and the laminated composite structure defines a plurality of perforations that continuously extend through at least the surface segment, the electrical segment, and the structural segment.

Clause 20. The laminated composite structure of Clause 18 or Clause 19, wherein the structural support layers of the structural segment include electrically conductive material, and the laminated composite structure comprises a dielectric bushing that is disposed within the thru-hole and surrounds the conductive insert to electrically insulate the conductive insert from the electrically conductive material of the structural support layers.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are example embodiments. Many other embodiments will be apparent to those of ordinary skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A laminated composite structure comprising:
a structural segment including multiple structural support layers in a stack;
an electrical segment disposed next to the structural segment along a thickness of the laminated composite structure, the electrical segment including at least a first embedded conductive element sandwiched between a first dielectric ply and a second dielectric ply, the electrical segment including at least a first bus strip that is electrically connected to an electrical load, the first embedded conductive element electrically connected to the first bus strip across the second dielectric ply; and
a first conductive insert loaded into a first thru-hole defined through the stack of the structural support layers, the first conductive insert electrically connected to the first embedded conductive element across the first dielectric ply to provide electrical circuit routing within the thickness of the laminated composite structure.

2. The laminated composite structure of claim 1, wherein the electrical load is a heater element including an electrically resistive ply that converts electrical energy to thermal energy, wherein the first bus strip is disposed between the first embedded conductive element and the electrically resistive ply along the thickness of the laminated composite structure.

3. The laminated composite structure of claim 1, wherein the structural support layers of the structural segment include electrically conductive material, and the laminated composite structure comprises a dielectric bushing that is disposed within the first thru-hole and surrounds the first conductive insert to electrically insulate the first conductive insert from the electrically conductive material of the structural support layers.

4. The laminated composite structure of claim 3, wherein the electrically conductive material comprises carbon fiber.

5. The laminated composite structure of claim 1, further comprising a second bus strip, a second conductive element, and a second conductive insert, wherein the second bus strip is spaced apart from the first bus strip, the second bus strip electrically connected to the electrical load, wherein the second conductive insert is loaded into a second thru-hole defined through the stack of the structural support layers, wherein the second embedded conductive element is electrically connected to a distal end of the second conductive insert and is electrically connected to the second bus strip such that the electrical circuit routing within the thickness of the laminated composite structure extends from the first conductive insert to the second conductive insert.

6. The laminated composite structure of claim 5, wherein the second embedded conductive insert is in-plane with the first embedded conductive insert and spaced apart from the first embedded conductive insert.

7. The laminated composite structure of claim 1, further comprising a surface segment that defines an exterior surface of a vehicle, wherein the electrical segment is disposed between the structural segment and the surface segment within the thickness of the laminated composite structure.

8. The laminated composite structure of claim 7, wherein the vehicle is an aircraft, and the laminated composite structure forms a portion of an inlet cowl of a nacelle.

9. The laminated composite structure of claim 8, wherein the laminated composite structure defines a plurality of perforations that continuously extend through the surface segment, the electrical segment, and the structural segment.

10. The laminated composite structure of claim 8, wherein the electrical load includes a first heater element and the first heater element is separated from a second heater element of a second laminated composite structure along a circumference of the inlet cowl by a seam, wherein the seam extends from a leading edge of the inlet cowl in an aft direction to define an oblique angle relative to a streamwise direction of airflow through the inlet cowl when in flight.

11. The laminated composite structure of claim 1, wherein the first conductive insert includes a shaft and a head, wherein at least a portion of the head is exposed beyond a top side of the structural segment and an external wire is electrically connected to the portion of the head that is exposed.

12. The laminated composite structure of claim 1, further comprising an inner face sheet and a cellular core layer, the cellular core layer disposed between the inner face sheet and the structural support layers within the thickness of the laminated composite structure.

13. A method of forming a laminated composite structure, the method comprising:
forming a structural segment to include multiple structural support layers in a stack;
forming an electrical segment disposed next to the structural segment along a thickness of the laminated composite structure, the electrical segment including an embedded conductive element sandwiched between a first dielectric ply and a second dielectric ply, the electrical segment including a bus strip that is electrically connected to an electrical load, the embedded conductive element electrically connected to the bus strip across the second dielectric ply; and
loading a conductive insert into a thru-hole defined through the stack of the structural support layers, the conductive insert electrically connected to the embedded conductive element across the first dielectric ply, wherein the embedded conductive element provides electrical circuit routing within the thickness of the laminated composite structure.

14. The method of claim 13, further comprising curing the laminated composite structure to bond the structural segment to the electrical segment.

15. The method of claim 13, wherein the structural support layers of the structural segment include electrically conductive material, and loading the conductive insert into the thru-hole comprises applying a dielectric bushing to surround the conductive insert prior to loading the conductive insert into the thru-hole such that the dielectric bushing electrically insulates the conductive insert from the electrically conductive material of the structural support layers.

16. The method of claim 13, further comprising forming a surface segment that defines an exterior surface of a vehicle, wherein the electrical segment is disposed between the structural segment and the surface segment within the thickness of the laminated composite structure.

17. The method of claim 16, further comprising forming a plurality of perforations that continuously extend through the surface segment, the electrical segment, and the structural segment.

18. A laminated composite structure comprising:
an inner face sheet;
a structural segment including multiple structural support layers in a stack;
a cellular core layer disposed between the inner face sheet and the structural support layers along a thickness of the laminated composite structure;
a surface segment that defines an exterior surface of an aircraft;
an electrical segment disposed between the surface segment and the structural segment along the thickness of the laminated composite structure, the electrical segment including an embedded conductive element sandwiched between a first dielectric ply and a second dielectric ply, the electrical segment including a bus strip that is electrically connected to an electrical load, the embedded conductive element electrically connected to the bus strip across the second dielectric ply; and
a conductive insert loaded into a thru-hole defined through the stack of the structural support layers, the conductive insert electrically connected to the embedded conductive element across the first dielectric ply for electrical circuit routing within the thickness of the laminated composite structure.

19. The laminated composite structure of claim 18, wherein the laminated composite structure forms a portion of an inlet cowl of a nacelle of the aircraft, and the laminated composite structure defines a plurality of perforations that continuously extend through at least the surface segment, the electrical segment, and the structural segment.

20. The laminated composite structure of claim 18, wherein the structural support layers of the structural segment include electrically conductive material, and the laminated composite structure comprises a dielectric bushing that is disposed within the thru-hole and surrounds the conductive insert to electrically insulate the conductive insert from the electrically conductive material of the structural support layers.
